(19) United States
(12) Patent Application Publication
(10) Pub. No.: US 2005/0168572 A1
(43) Pub. Date: Aug. 4, 2005

(54) Vehicle on-board adapter and on-board system using thereof

(75) Inventor: Satoshi Yoshida, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KANACK PLANNING CORPORATION, Tokyo (JP)

(21) Appl. No.: 10/812,930

(22) Filed: Mar. 31, 2004

(30) Foreign Application Priority Data
Jan. 30, 2004 (JP) 2004-024463

(51) Int. Cl. H04N 7/18

(52) U.S. Cl. 348/118

(57) ABSTRACT

A display output terminal is connected to a genuine vehicle on-board display unit. A first image input terminal is connected to a non-genuine image output equipment. Also, a second image input terminal is connected to a genuine vehicle on-board image output equipment. A circuit portion delivers at lease one of a signal S1 fed to the first image input terminal, and a signal S2 fed to the second image input terminal, from the display output terminal.

### BACKGROUND OF THE INVENTION

The present invention relates to a vehicle on-board adapter and an on-board system using thereof. In particular, the present invention relates to a vehicle on-board adapter which is used for adapting a non-genuine image output equipment to a system composed of, for example, a genuine display unit, an air-conditioner, an audio equipment and the like.

1. Description of the Related Art

There have been known, as genuine components in an automobile, an air-conditioner, an audio equipment, a GPS navigation device, a display unit and the like, which are connected with one another in a LAN so as to constitute a genuine vehicle on-board image system. The genuine image system is configured to display data related to temperature control of the air-conditioner, sound volumes of the audio equipment, a location of an automobile measured by the GPS, and the like.

These years, thanks to rapid progress of electronic equipments, there have been commercially increased needs of taking images output from a portable video/DVD unit or a GPS navigation device or the like having a performance higher than that of the corresponding genuine component, into the genuine vehicle on-board image system.

However, in general, the genuine display unit does not usually incorporate a terminal unit for receiving image signals output from a non-genuine equipment, and accordingly, there has been raised such a problem that an additional display unit should be used in addition to the genuine display unit within a narrow passenger compartment, in order to display the image signals output from the non-genuine equipment.

Further, the configuration of the genuine display unit is in general extremely complicated since it is integrally incorporated with a LDP drive circuit for displaying images, a LAN circuit, a CPU and the like in order to reduce the size and the cost. Thus, the analysis of the configuration of the genuine display unit has resulted in substantial impossibility of manufacturing a display unit which has a function identical with the function of the genuine display unit and which incorporates terminals for inputting image signals from a non-genuine equipment. In fact, there have been found no documents which disclose a technology of introducing image signals delivered from a non-genuine equipment, into a genuine vehicle on-board image system.

For example, Japanese Laid-Open Patent No. 2003-198546 (patent document 1) discloses a vehicle on-board audio interface adapter adapted for using a non-genuine head unit in lieu of a genuine deck tuner (head unit) constituting a genuine vehicle on-board system although it is not the one introducing image signals delivered from a non-genuine equipment into a genuine vehicle on-board image system. The vehicle on-board audio interface adapter disclosed in the patent document 1 incorporates a microcomputer circuit which produces LAN signals equivalent to those produced by the genuine head unit, and accordingly, even though the non-genuine head unit is used, an air-conditioner or the like constituting the genuine vehicle on-board system can continue its operation.

However, in the configuration disclosed in the patent document 1, since a genuine component is replaced with a non-genuine component, it has been required to analyze all signals delivered from the genuine component in order to cause the microcomputer circuit to produce signals equivalent to the former so as to operate the LAN normally.

Thus, there have been caused problems, that is, necessity of a lot of time and labor for analysis of signals, and a low degree of general-purpose due to requirement of analysis of signals for every automobile manufacturer or every vehicle kind.

### SUMMARY OF THE INVENTION

An object of the present invention is to provide a vehicle on-board adapter capable of transmitting image signals delivered from a non-genuine image output equipment to a genuine vehicle on-board image system, and a vehicle on-board system using thereof.

Another object of the present invention is to provide a vehicle on-board adapter capable of easily adding a non-genuine image output equipment to a genuine vehicle on-board image system, and a vehicle on-board system using thereof.

Further, another object of the present invention is to provide a vehicle on-board adapter of general purpose which does not depend upon a vehicle manufacturer, a kind of a vehicle or the like.

To the end, according to the present invention, there is provided a vehicle on-board adapter comprising a display output terminal, a first image input terminal, a second image input terminal and a circuit portion. The display output terminal is adapted to be connected to a genuine vehicle on-board display unit. The first image input terminal is adapted to be connected a non-genuine image output equipment. The second image input terminal is adapted to be connected to a genuine vehicle on-board image output equipment.

The circuit portion outputs at lease one of a signal fed to the first image input terminal and a signal fed to the second image input terminal, from the display output terminal.

The vehicle on-board adapter according to the present invention is combined with the genuine vehicle on-board display unit, the genuine vehicle on-board image output equipment and the non-genuine image output equipment so as to constitute a vehicle on-board system. The genuine vehicle on-board display unit is connected to the display output terminal. The non-genuine image output equipment is connected to the first image input terminal. The genuine vehicle on-board image output equipment is connected to the second image input terminal. The genuine vehicle on-board display unit displays a signal fed from the display output terminal, in the form of an image, on the basis of signals fed to the first image input terminal and the second image input terminal.

It is noted here that the vehicle on-board adapter according to the present invention includes the circuit portion which delivers at least one of a signal fed to the first image input terminal and a signal fed to the second image input terminal, from the display output terminal. Thus, with the use of the vehicle on-board adapter according to the present invention, not only image data delivered from the genuine vehicle on-board image output equipment but also image data delivered from the non-genuine image output equipment can be displayed on the genuine vehicle on-board display unit in the form of an image.

Thus, with the vehicle on-board adapter according to the present invention, since image signals delivered from the non-genuine image output equipment can be fed to the genuine vehicle on-board image system, an equipment such as a latest portable image media equipment, a general purpose image media equipment or a special image media equipment, which has been brought into a vehicle, can display an image on the genuine vehicle on-board display unit with no affection upon the genuine vehicle on-board image system.

Further, the vehicle on-board adapter according to the present invention is added to the existing vehicle on-board image system including the genuine vehicle on-board display unit without replacement of the genuine vehicle on-board display unit. Thus, even though the vehicle on-board adapter according to the present invention is incorporated, LAN signals or the like transmitted and received by the genuine vehicle on-board display unit or the like can be transmitted and received, similar to that before the application thereof.

Thus, it is not necessary to analyze the LAN signals or the like delivered from the genuine vehicle on-board display unit or the like in order to produce signals equivalent thereto, and occurrence of a problem of requiring a lot of time and labor for the analysis can be prevented. The vehicle on-board adapter according to the present invention can be incorporated in the genuine vehicle on-board image system only by connecting the same between the image input terminal of the genuine vehicle on-board display unit and the image output terminal of the genuine vehicle on-board image output equipment.

Further, since it is not required to generate the LAN signals or the like which the genuine vehicle on-board display unit or the like, the vehicle on-board adapter is of general purpose type which does not depend upon a vehicle manufacturer, a kind of a vehicle or the like.

Further, according to the present invention, the genuine vehicle on-board equipment is the one which is a vehicle on-board equipment manufactured by a vehicle manufacturer, a vehicle on-board equipment having a name of a vehicle manufacturer, a vehicle on-board equipment which is guaranteed by a vehicle manufacturer so as to be adapted to a concerned vehicle, a vehicle on-board equipment which is described in a brochure as it can be adapted to a concerned vehicle, or the like.

As to the genuine vehicle on-board display unit, there may be enumerated the one which displays characters, graphics or the like, which displays a moving image or which displays a still picture. The genuine vehicle on-board display unit may be not only the one which receive image data but the one which transmits and receive LAN (Local Area Network) data or the like.

The genuine vehicle on-board image output equipment delivers data displayed as an image, and constitutes a genuine vehicle on-board image system in cooperation with the genuine vehicle on-board display unit.

As to the genuine vehicle on-board image output equipment, there may be enumerated a genuine vehicle on-board air-conditioner, a genuine vehicle on-board audio equipment, a genuine vehicle on-board GPS (Global Positioning System) navigation system and the like. The genuine vehicle on-board image output equipment may be not only the one which delivers image data but also the one which transmits and receives LAN data or the like.

The non-genuine image output equipment is the one which delivers data to be displayed in the form of an image, and constitutes an image system in cooperation with the genuine vehicle on-board display unit. The non-genuine image output equipment is the one which is not a genuine vehicle on-board equipment, but may be a non-genuine vehicle on-board equipment or a general purpose image output equipment other than the vehicle on-board equipments.

As to the non-genuine vehicle on-board image output equipment, there may be enumerated a portable video reproducing equipment, a portable DVD reproducing equipment, a non-genuine vehicle on-board GPS navigation system, a non-genuine vehicle on-board audio equipment and the like. As to the non-genuine vehicle on-board equipment, there may be included a vehicle on-board equipment which is guaranteed by a manufacturer of a vehicle on-board equipment so as to be interchangeable with a genuine vehicle on-board equipment but which is not guaranteed as being interchangeable with a genuine vehicle on-board equipment, by a vehicle manufacture.

Other features, and technical effects and advantages of the present invention will become more apparent in the following description of preferred embodiments with reference to the accompanying drawings.

### BRIEF DESCRIPTION OF THE DRAWINGS

FIG. 1 is a block diagram illustrating an embodiment of a vehicle on-board system according to the present invention;

FIG. 2 is a block diagram for explaining, in detail, a vehicle on-board adapter shown in FIG. 1;

FIG. 3 is a block diagram illustrating another embodiment of the vehicle on-board adapter according to the present invention;

FIG. 4 is a further another embodiment of the vehicle on-board adapted according to the present invention;

FIG. 5 is a further another embodiment of the vehicle on-board adapted according to the present invention;

FIG. 6 is a further another embodiment of the vehicle on-board adapted according to the present invention;

FIG. 7 is a further another embodiment of the vehicle on-board adapted according to the present invention;

FIG. 8 is a further another embodiment of the vehicle on-board adapted according to the present invention;

FIG. 9 is a further another embodiment of the vehicle on-board adapted according to the present invention;

FIG. 10 is a further another embodiment of the vehicle on-board adapted according to the present invention; and

FIG. 11 is a further another embodiment of the vehicle on-board adapted according to the present invention.

### DESCRIPTION OF THE PREFERRED EMBODIMENTS

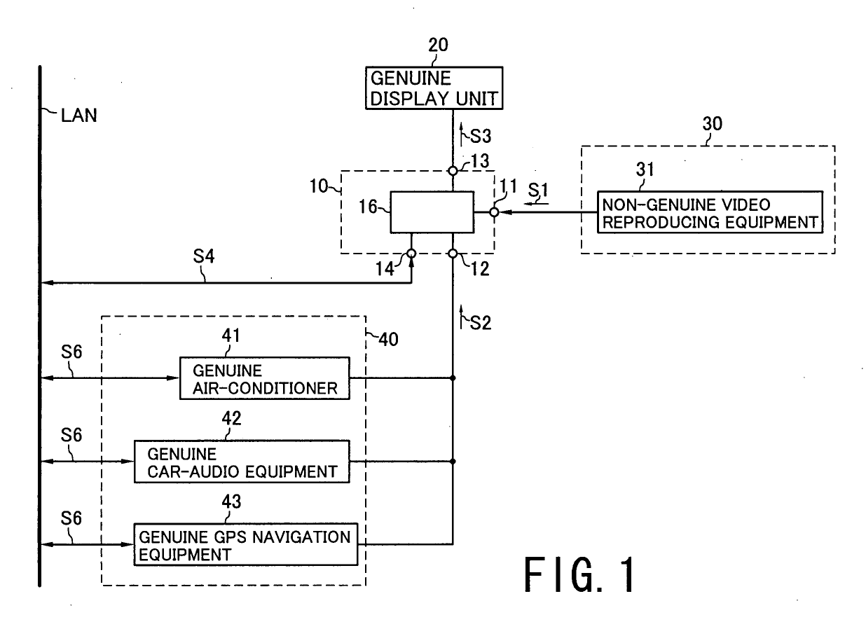

Referring to FIG. 1, a vehicle on-board system includes a vehicle on-board adapter 10, a genuine vehicle on-board display unit 20, a genuine vehicle on-board image output equipment 40 and a non-genuine image output equipment 30. The genuine vehicle on-board display unit is, for example, a liquid crystal display unit.

The non-genuine image output equipment 30 includes a portable video reproducing equipment 31 which is not a genuine vehicle on-board equipment. The non-genuine image output equipment 30 may be a portable DVD reproducing equipment or a non-genuine vehicle on-board audio equipment or the like.

The genuine vehicle on-board image output equipment 40 is the one which constitutes a genuine image system in cooperation with the genuine vehicle on-board display unit 20. For example, referring to the figure, the genuine vehicle on-board image output equipment 40 includes a genuine vehicle on-board air-conditioner 41, a genuine vehicle on-board car-audio equipment 42 and a genuine vehicle on-board GPS navigation equipment 43.

The vehicle on-board adapter 10 is a vehicle on-board interface adapter according to the present invention, and includes a display image output terminal 13, a first image input terminal 11, a second image input terminal 12 and a circuit portion 16.

The display output terminal 13 is connected to the genuine vehicle on-board display unit 20. The first image input terminal 11 is connected to the non-genuine image output equipment 30. The second image input terminal 12 is connected to the genuine vehicle on-board image output equipment 40.

In the vehicle on-board system as shown, the non-genuine image output equipment 30 feeds an image signal S1 to the image input terminal 11 of the vehicle on-board adapter 10. The genuine vehicle on-board image output equipment 40 delivers an image signal S2 to the second image input terminal 12 in the vehicle on-board adapter 10, and as a result, transmits and receives a LAN signal S6. The genuine vehicle on-board image output equipment 40 may carry out operation such as output of an image or the like, on the basis of the LAN signal S6.

The circuit portion 16 in the vehicle on-board adapter 10 delivers at least one of the image signal S1 fed from the first image input terminal 11 and the image signal S2 fed from the second image input terminal 12, as a image signal S3, to the display output terminal 13.

The circuit portion 16 may have a switch function for feeing, for example, one of the first image signal 11 and the second image signal 12 to the display output terminal 13, or may be composed of a wiring connecting between the display output terminal 13 and the first image input terminal 11 and a wiring connecting between the display output terminal 13 and the second image input terminal 12. The genuine vehicle on-board display unit 20 displays the image signal S3 fed from the vehicle on-board adapter 10, in the form of an image.

As stated above, the vehicle on-board adapter 10 according to the present invention includes the circuit portion 16 which delivers at least one of the signal S1 fed from the first image input terminal 11 and the signal S2 fed from the second image input terminal 12, to the display output terminal 13. Thus, with the use of the vehicle on-board adapter 10 according to the present invention, not only image data delivered from the genuine vehicle on-board image output equipment 40 but also image data delivered from the non-genuine image output equipment 30 can be displayed in the form of an image on the genuine vehicle on-board display unit 20.

Thus, with the vehicle on-board adapter 10 according to the present invention, the image signal S1 delivered from the non-genuine image output equipment 30 can be fed to the genuine vehicle on-board image system, and accordingly, image data from an equipment such as a latest portable image media equipment, a general purpose image media equipment or a special image media equipment or the like which has been brought into a vehicle can be displayed in the form of an image on the genuine vehicle on-board display unit 20 with no affection upon the genuine vehicle on-board image system.

Further, the vehicle on-board adapter 10 according to the present invention is added to the existing genuine vehicle on-board image system including the genuine vehicle on-board display unit 20, instead of replacement of the genuine vehicle on-board display unit 20 or the like. Thus, even though the vehicle on-board adapter 10 according to the present invention is applied, LAN signals transmitted and received by the genuine vehicle on-board display unit 20 or the like can be transmitted and received, similar to that before the application thereof.

Accordingly, it is not necessary to analyze LAN signals or the like delivered from the genuine vehicle on-board display unit 20 or the like so as to produce signals equivalent thereto, and accordingly, there is caused no problem of requiring a lot of time and labor for the analysis. The vehicle on-board adapter 10 according to the present invention can be incorporated in the genuine vehicle on-board image system only by connecting the same between the image input terminal of the genuine vehicle on-board display unit 20 and the input terminal of the genuine vehicle on-board image output equipment 40.

Further, the vehicle on-board adapter 10 according to the present invention may be a general purpose adapter which does not depend upon a vehicle manufacturer or a kind of a vehicle since it is not required to produce LAN signals or the like delivered from the genuine vehicle on-board display unit 20 or the like.

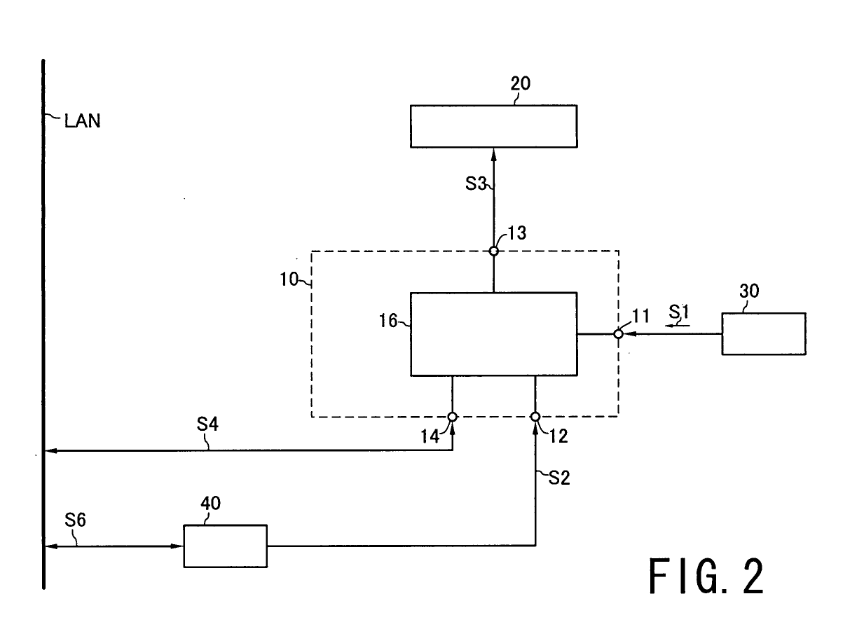

Referring to FIG. 2 which is a block diagram for explaining, in further detail, the vehicle on-board adapter shown in FIG. 1, the non-genuine image output equipment 30 feeds the image signal S1 to the first image input terminal 11 of the vehicle on-board adapter 10. The genuine vehicle on-board image output equipment 40 feeds the image signal S2 to the second image input terminal 12, and as a result, transmits and receives the LAN signal S6.

The vehicle on-board adapter 10 delivers at least one of the image signal S1 and the image signal S2 from the display output terminal 13. The vehicle on-board adapter 10 may transmit and receive a control result as a LAN signal S4 to and from the terminal 14, and may grasp a condition or the like of the genuine vehicle on-board image output equipment 40 with the use of the LAN signal S4 delivered from the terminal 14.

The genuine vehicle on-board display unit 20 displays thereon the image signal S3 fed from the vehicle on-board adapter 10 in the form of an image. Referring to FIG. 2, since the LAN signal does not include data relating to the control of the genuine vehicle on-board display unit 20, the genuine vehicle on-board display unit 20 does not transmit and receive the LAN signal.

The genuine vehicle on-board display unit 20 is fed thereto with an image signal, similar to that before the addition of the non-genuine image output equipment 30. That is, the genuine vehicle on-board display unit 20 is fed thereto with the image signals S1, S2 in addition to the image signal S2 which has been conventionally fed. Thus, even though the non-genuine image output equipment 30 is added, the vehicle on-board adapter 10 has a function (emulation) which constitutes an image system like to the genuine image system.

Accordingly, the genuine vehicle on-board display unit 20 can display thereon at least one of the image signal S2 produced by the genuine vehicle on-board image output equipment 40 and the image signal S1 produced by the non-genuine image output equipment 30, in the form of an image.

Further, the genuine vehicle on-board image output equipment 40 can exhibit its normal function similar to that before the addition of the non-genuine image output equipment 30 since it is not affected by the addition of the non-genuine image output equipment 30.

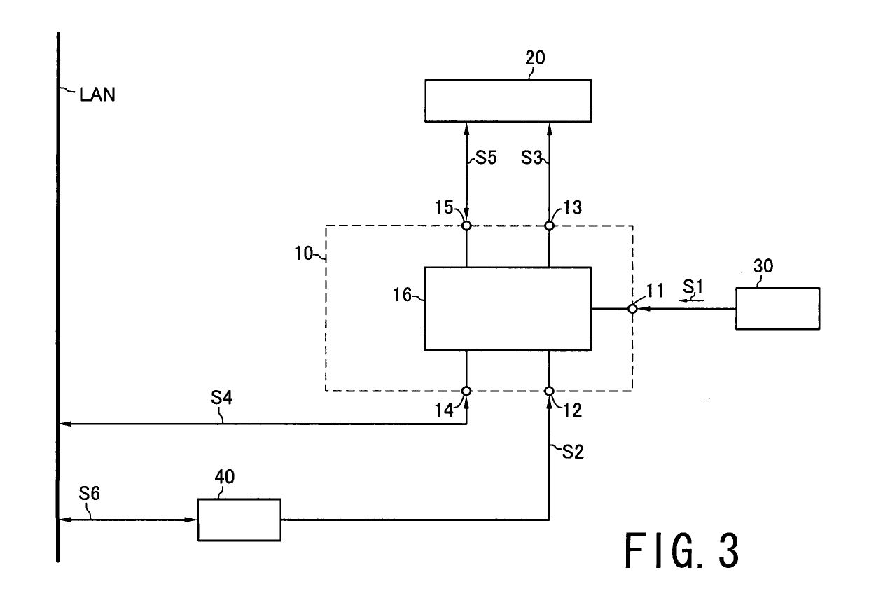

Next, explanation will be made of other embodiments of the vehicle on-board adapter and the vehicle on-board system according to the present invention, with reference to FIGS. 3 to 11 in which like reference numerals are use to denote like component parts shown in the figures explained hereinabove in order to omit the explanation thereof.

At first, referring to FIG. 3, a vehicle on-board adapter 10 has an emulating function similar to that of the vehicle on-board adapter shown in FIG. 1.

In the case of delivering the image signal S1 as the image signal S3, the vehicle on-board adapter 10 transmits and receives a quasi LAN signal S5 which indicates that the image signal S3 is a signal delivered from the non-genuine image output equipment 30, to and from a terminal 15. For example, the equipments constituting the genuine vehicle on-board image system are allocated thereto with addresses, respectively, and if the genuine vehicle on-board display unit 20 is operated on the basis of its address, a predetermined address which has not yet been allocated to any of other equipments can be used as the quasi LAN signal S5.

The vehicle on-board adapter 10 may transmit or receive data included in the LAN signal S4 as the quasi LAN signal S5 if the LAN signal S4 includes data relating to a condition of the genuine vehicle on-board image output equipment 40 or the like.

With this configuration, the genuine vehicle on-board display unit 20 can display data concerning an equipment from which an image signal is delivered in addition to the image signal S3. The genuine vehicle on-board display unit 20 may transmit and receive the quasi LAN signal S5 as a result of control to and from the vehicle on-board adapter 10.

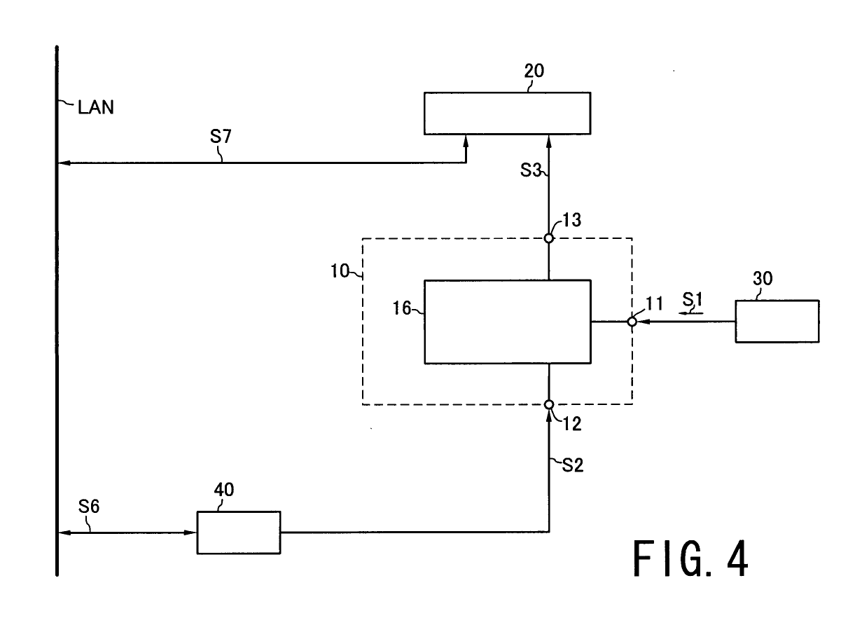

Next, referring to FIG. 4, a vehicle on-board adapter 10 has an emulating function similar to the vehicle on-board adapter shown in FIG. 2.

The genuine vehicle on-board display unit 20 transmits and receives a LAN signal S7 which includes data concerning a control instruction for the genuine vehicle on-board display unit 20, a result of control of the genuine vehicle on-board display unit 20 and the like. For example, the LAN signal S7 includes data for controlling the turn-on and -off of a power source for the genuine vehicle on-board display unit 20. Accordingly, the genuine vehicle on-board display unit 20 can carry out control operation, transmission of a result of control or the like, on the basis of the LAN signal S7.

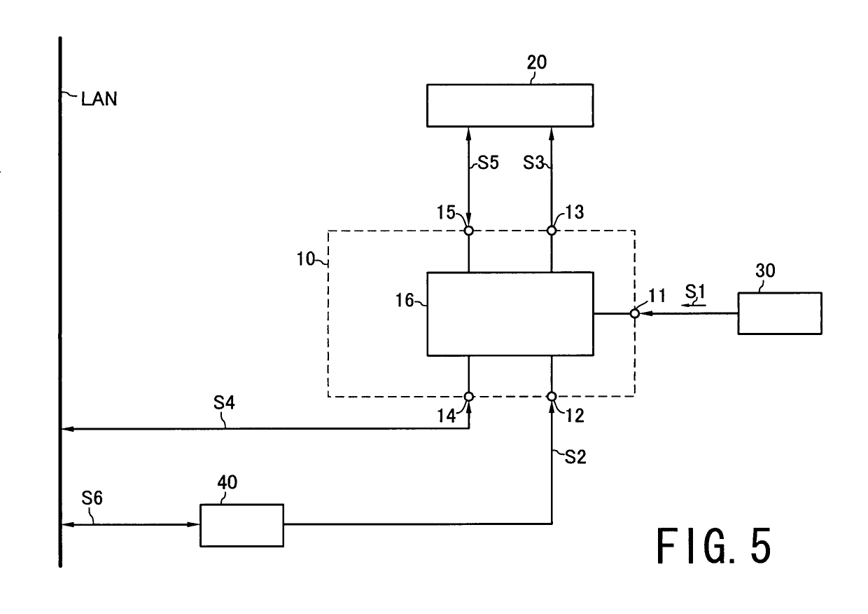

Referring to FIG. 5, a vehicle on-board adapter 10 has a gate way function.

The vehicle on-board adapter 10 is fed thereto with the image signals S1, S2 from the first image input terminal 11 and the second image input terminal 12, and delivers the image signal S3 from the display terminal 13. Further, the vehicle on-board adapter 10 transmits and receives the LAN signal S4 to and from the terminal 14, and transmits and receives the signal S5 to and from the genuine vehicle on-board display unit 20. The signal S5 may be the one which includes the quasi LAN signal having been explained with reference to FIG. 3.

The signal S5 delivered from the vehicle on-board adapter 10 preferably includes only data necessary for controlling the genuine vehicle on-board display unit 20. Further, the signal S5 delivered from the vehicle on-board display unit 20 can be transmitted and received as the LAN signal S4.

In the vehicle on-board system as shown, the vehicle on-board adapter 10 transmits only required those of data and the like included in the LAN signal S4 with no affection upon a conventional genuine image system, and is then displayed on the genuine vehicle on-board display unit 20, and accordingly, it is possible to materialize the gate-way function.

Since the vehicle on-board adapter and the vehicle on-board system which are shown in the figure have configurations similar to those shown in FIGS. 1 to 4, similar technical effects and advantages can be obtained.

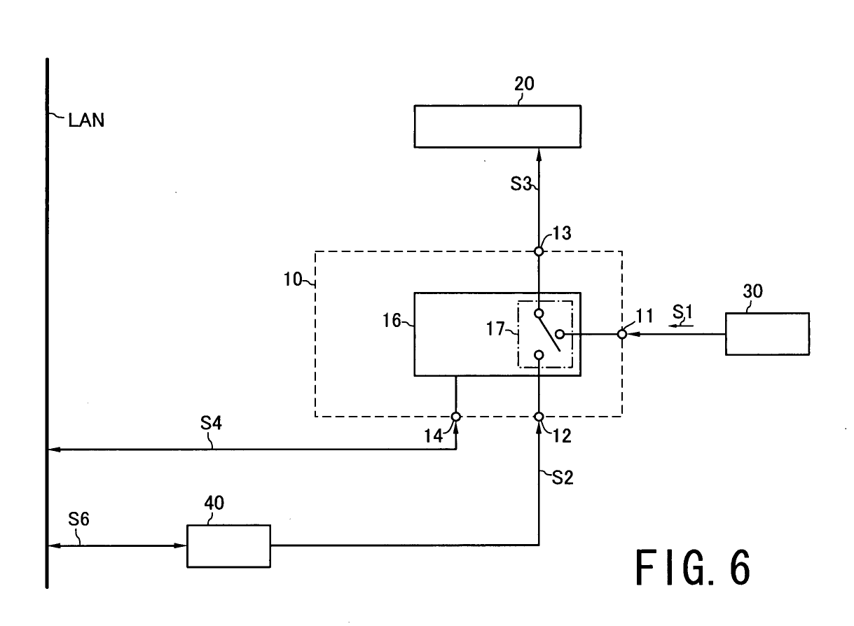

Referring to FIG. 6, the circuit portion 16 of the vehicle on-board adapter 10 includes a switch means 17 which is connected to the input image signal 11, the second input image signal 12 and the display output terminal 13, and connects the one of the first input image terminal 11 and the second input image terminal 12 to the display output terminal 13.

In the vehicle on-board system as shown, the vehicle on-board adapter 10 connects one of the first image input terminal 11 and the second image input terminal 12 to the display output terminal 13, and accordingly, it is possible to exhibit such a switching function that the image signal S1 fed from the first image input terminal 11 and the image signal S2 fed from the second image input terminal 12 can be alternatively used so as to be delivered as the image signal S3 from the display output terminal 13.

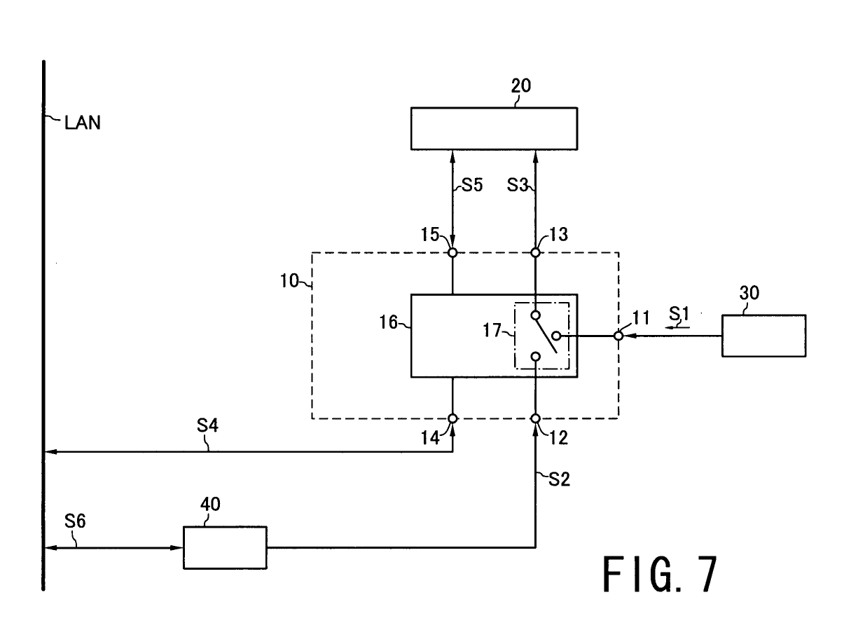

Referring to FIG. 7, the circuit portion 16 of the vehicle on-board adapter 10 includes a switch means 17. The vehicle on-board adapter 10 transmits and receives the quasi LAN signal S5 to and from the terminal 15, similar to the vehicle on-board adapter 10 shown in FIG. 3.

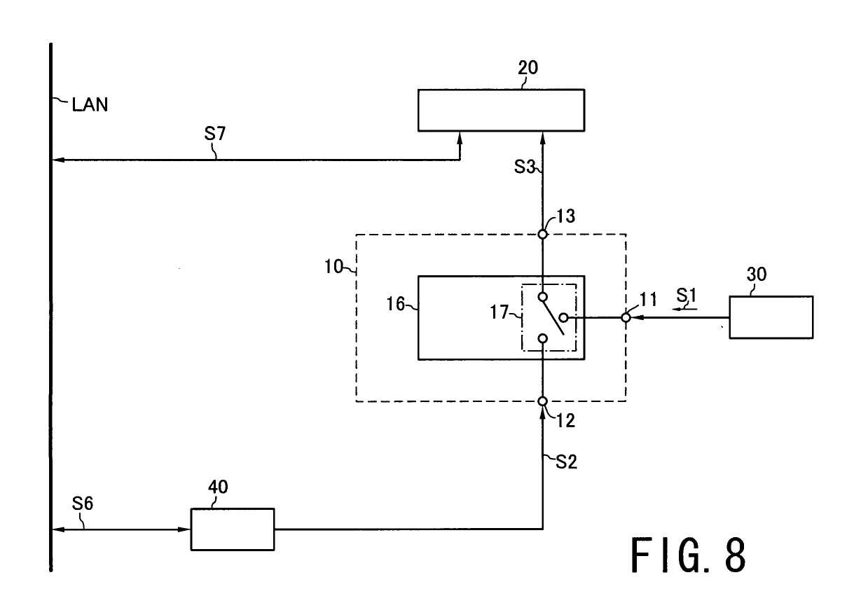

Referring to FIG. 8, the circuit portion 16 of the vehicle on-board adapter 10 includes a switch means 17. The genuine vehicle on-board display unit 20 transmits and receives a LAN signal S7 similar to the vehicle on-board adapter 10 shown in FIG. 4.

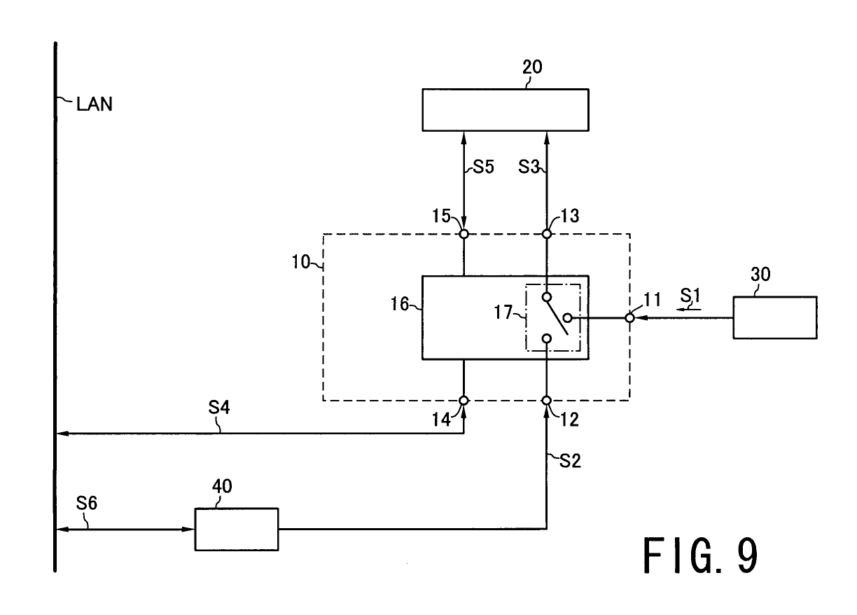

Referring to FIG. 9, the circuit portion 16 of the vehicle on-board adapter 10 includes a switch means 17. The vehicle on-board adapter 10 transmits the LAN signal S4 to and from the terminal 14, similar to the vehicle on-board adapter 10 shown in FIG. 5, and also transmits and receives the signal S5 to and from the genuine vehicle on-board display unit 20.

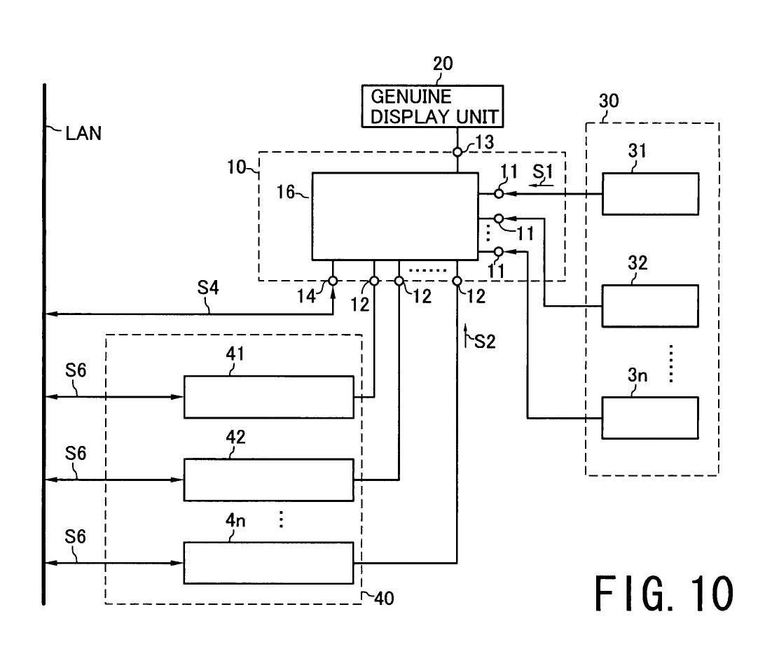

Referring to FIG. 10, the genuine vehicle on-board image output equipment 40 is composed of a plurality of genuine vehicle on-board image output equipments 41, 42 4n. The non-genuine image output equipment 30 is composed of a plurality of non-genuine image output equipments 31, 32 . . . 3n. The vehicle on-board adapter 10 has a plurality of first image input terminals 11, and a plurality of image output terminals 12.

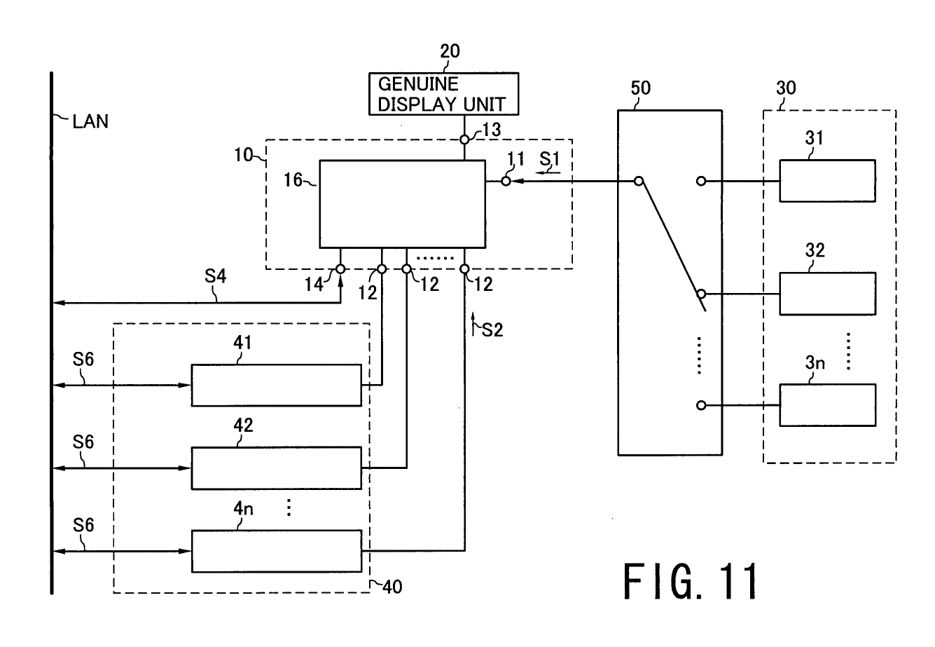

Referring to FIG. 11, the vehicle on-board system incorporates a switch device 50 between the vehicle on-board adapter 10 and the non-genuine image output equipments 30. The vehicle on-board adapter 10 has only one first image input terminal 11. The switch device 50 selects any one of the plurality of the non-genuine image output equipments 30, and connects the same to the first image input terminal 11 of the vehicle on-board adapter 10.

Since the vehicle on-board adapters 10 and the vehicle on-board systems in the embodiments shown FIGS. 3 to 11 have substantially similar configurations to those of the vehicle on-board adapter and the vehicle on-board system shown in FIGS. 1 and 2, similar technical effects and advantages can be obtained.

Further, in the embodiments as stated above, the image signal S1 fed to the first image input terminal 11 and the image signal S2 fed to the second image input terminal 12, and as well, the image signal S3 delivered from the display output terminal 13 may be either analog or digital.

Although the present invention has been specifically described in the preferred embodiment forms, it is self-explanatory that the those skilled in the art can make various modification and changes in view of the technical concept and disclosure of the present invention.

1. A vehicle on-board adapter including a display output terminal, a first image input terminal, a second image input terminal and a circuit portion,
the display output terminal being the one which is connected to a genuine vehicle on-board display unit,
the first image input terminal being the one which is connected to a non-genuine image output equipment,
the second image input terminal being the one which is connected to a genuine vehicle on-board image output equipment, and
the circuit portion delivering at least one of a signal fed to the first image input terminal and a signal fed to the second image input terminal, from the display output terminal.

2. A vehicle on-board adapter according to claim 1, further comprising a terminal for transmitting and receiving a LAN signal which indicates a control result of the circuit portion.

3. A vehicle on-board adapter according to claim 1, further comprising a terminal for receiving a LAN signal for grasping a condition of the genuine vehicle on-board image output equipment.

4. A vehicle on-board adapter according to claim 1, further comprising a terminal for transmitting and receiving a quasi LAN signal, which indicates that the signal fed to the first image input terminal is delivered from the display output terminal or the signal fed to the second image input terminal is delivered from the display output terminal.

5. A vehicle on-board adapter according to claim 4, further comprising a terminal for receiving a LAN signal for grasping a condition of the genuine vehicle on-board image output equipment,
the LAN signal for grasping a condition of the genuine vehicle on-board image output equipment includes said quasi LAN signal.

6. A vehicle on-board system including a vehicle on-board adapter, a genuine vehicle on-board display unit, a genuine image output equipment and a non-genuine image output equipment,
the vehicle on-board adapter being as set forth in claim 1,
the genuine vehicle on-board display unit being connected to the display output terminal,
the non-genuine vehicle on-board image output equipment being connected to the first image input terminal,
the genuine vehicle on-board image output equipment being connected to the second image input terminal, and
the genuine vehicle on-board display unit displaying thereon a signal fed from the display output terminal in the form of an image, on the basis of the signal fed to the first image input terminal or the second image input terminal.
